(19) United States
(12) Patent Application Publication
(10) Pub. No.: US 2025/0343759 A1
(43) Pub. Date: Nov. 6, 2025

(54) SYSTEMS AND METHODS FOR DETECTING BLOCKED TRAFFIC FLOWS IN VOICE RELATED SERVICES

(71) Applicant: Verizon Patent and Licensing Inc., Basking Ridge, NJ (US)

(72) Inventors: Radhika KORLAPATI, Hyderabad (IN); Amisha Amber TOLAT, Somerset, NJ (US); Ramesh PONDUGALA, Hyderabad (IN); Sachin IYENGAR, John's Creek, GA (US); Josy JOHN, Wesley Chapel, FL (US)

(73) Assignee: Verizon Patent and Licensing Inc., Basking Ridge, NJ (US)

(21) Appl. No.: 18/655,738

(22) Filed: May 6, 2024

(51) Int. Cl. H04L 47/12; H04L 41/5009; H04L 65/80

(52) U.S. Cl. CPC H04L 47/12; H04L 41/5009; H04L 65/80

(57) ABSTRACT

In some implementations, a network device may receive a key performance indicator (KPI) metric associated with a media resource function, wherein the media resource function is associated with a virtualized telephone application service. The network device may compare the KPI metric to a threshold. The network device may generate an internal event based on the KPI metric satisfying the threshold. The network device may correlate the internal event and an external event, wherein the external event is based on external system formulated data, and correlation results include an indication of non-matching data or matched data between the internal event and the external event. The network device may identify a blocked voice traffic flow based on the correlation results. The network device may transmit a notification that indicates the blocked voice traffic flow, wherein the notification includes a recommendation to resolve the blocked voice traffic flow.

### BACKGROUND

Communication systems are widely deployed to provide various telecommunication services such as telephony, video, data, messaging, and broadcasts. A network may include one or more network nodes that support communication for wireless communication devices.

### BRIEF DESCRIPTION OF THE DRAWINGS

FIG. 1 is a diagram of an example associated with voice applications and associated media resource function (MRF) applications.

FIG. 2 is a diagram of an example associated with detecting blocked traffic flows in voice related services.

FIG. 3 is a diagram of an example associated with detecting blocked traffic flows in voice related services.

FIG. 4 is a diagram of an example environment in which systems and/or methods described herein may be implemented.

FIG. 5 is a diagram of example components of one or more devices of FIG. 4.

FIG. 6 is a flowchart of an example process associated with detecting blocked traffic flows in voice related services.

### DETAILED DESCRIPTION OF EXAMPLE EMBODIMENTS

The following detailed description of example implementations refers to the accompanying drawings. The same reference numbers in different drawings may identify the same or similar elements.

A wireless network may support virtualized and containerized technologies. For example, network virtualization may refer to an abstraction of network resources. Network virtualization may combine multiple physical networks to one virtual, software-based network, or network virtualization may divide one physical network into separate, independent virtual networks. Container networking may refer to different containers, isolated from a host device, where each container may be a separate environment with its own users file system, processes, and/or network stack. An application inside a given container may be permitted to access or modify files or resources available inside that container only.

The wireless network may involve deployments of network devices (e.g., routers or switches) and/or upgrades of the network devices, which may occur at a plurality of layers, including hardware layers, firmware layers, and/or software layers. Existing network devices may be replaced with new network devices. The existing network devices may periodically be upgraded with new firmware and/or hardware. When a license expires for the network device (e.g., a license expires for firmware on a router or switch), the license may need to be renewed. During such processes associated with replacements, upgrades, or license expirations, any incompatibility platform issues or downtime issues may impact the functioning of the network devices, which may further impact a virtualized application traffic flow.

For example, telephone application services, which function to take telephone application related traffic, may suffer a failure (e.g., a glitch) when an underlying router's switchover occurs. The switchover may involve a replacement of the router, an upgrade of the router, or a license renewal for the router. The failure may directly impact audio calls of individual users or conference calls of groups of users when the audio calls are served by the router. An inability to identify affected telephone application services that are not able to take traffic hosted on a platform may degrade an overall system performance.

In some implementations, in a detection of blocked traffic flow in Voice over Long Term Evolution (LTE) (VoLTE) services, a voice traffic flow may be self-regulated based on an identification of a telephone application services traffic health. The telephone application services traffic health may be identified using key performance indicator (KPI) metrics of media resource functions associated with the telephone application services. Unique threshold factor models may be applied on high-dimensional time zone and location data. Internal events may be dynamically correlated with external events, and notifications may be provided with appropriate recommendations to unblock traffic flows. As a result, by identifying and enabling a self-regulating process of unblocking the traffic flows within VoLTE services, the traffic flows associated with the telephone application services may be improved, thereby improving an overall system performance. The unblocking of traffic may result in improved audio quality in voice calls and/or less dropped audio calls, which may result in the improved overall system performance.

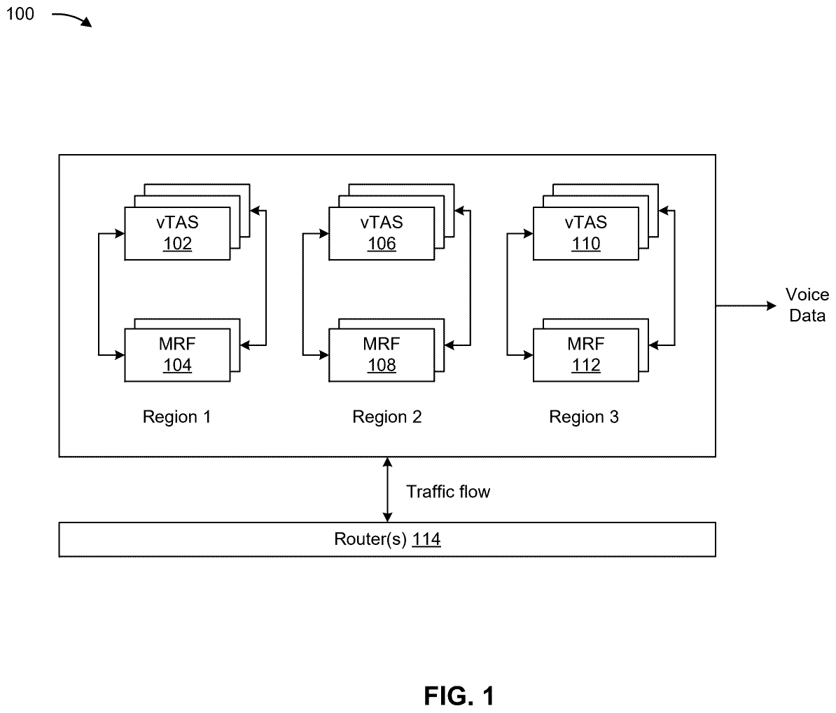

FIG. 1 is a diagram of an example 100 associated with voice applications and associated MRF applications. As shown in FIG. 1, example 100 includes a first virtualized telephone application service (vTAS) 102 and a first media resource function MRF 104 associated with a first region, a second virtualized telephone application service 106 and a second media resource function 108 associated with a second region, a third virtualized telephone application service 110 and a third media resource function 112 associated with a third region, and one or more routers 114.

As shown in FIG. 1, a wireless network may be associated with a plurality of different regions. For example, a first region may include one or more virtualized telephone applications 102 and one or more media resource functions 104, a second region may include one or more virtualized telephone applications 106 and one or more media resource functions 108, and a third region may include one or more virtualized telephone applications 110 and one or more media resource functions 112. One or more routers 114 may support traffic flow in the plurality of different regions, where the traffic flow may be associated with voice data.

The one or more virtualized telephone applications 102, 106, 110 may provide voice-related services over wireless networks. The one or more virtualized telephone applications 102, 106, 110 may be deployed as active/active geo-pair locations in Internet Protocol multimedia subsystem (IMS) VoLTE segments. The one or more virtualized telephone applications 102, 106, 110 may be connected to the one or more media resource functions 104, 108, 112, respectively, to provide media related data. The one or more media resource functions 104, 108, 112 may be components of an IMS. The one or more media resource functions 104, 108, 112 may provide media related functions, like the playing of announcements and tones. The one or more media resource functions 104, 108, 112 may support media mixing and conferencing functionalities. The one or more media resource functions 104, 108, 112 may be associated with the one or more virtualized telephone applications 102, 106, 110, respectively.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

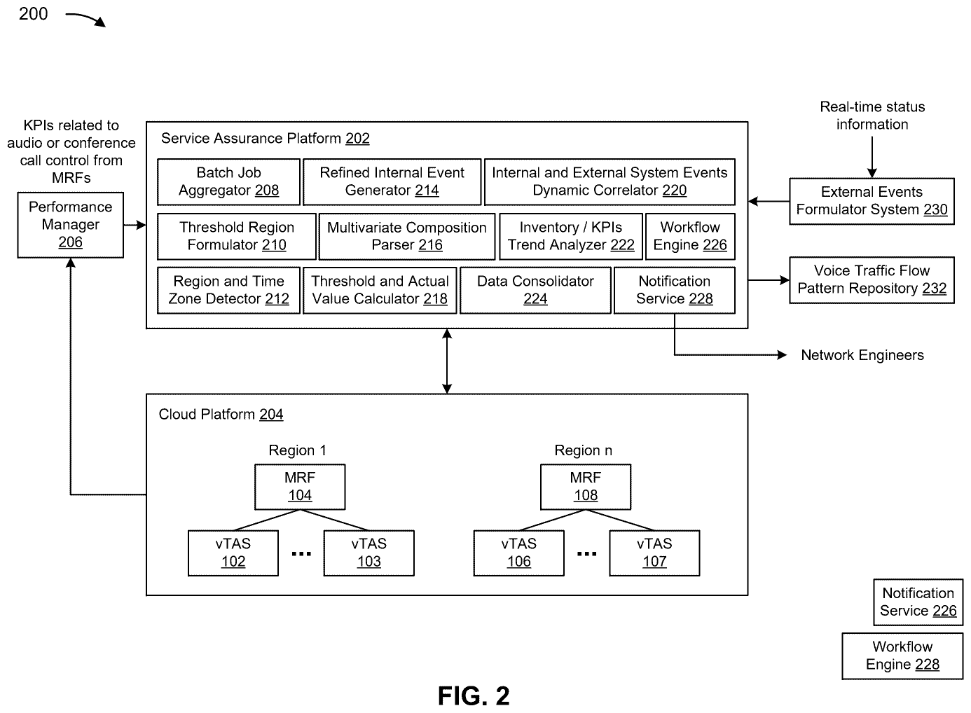

FIG. 2 is a diagram of an example 200 associated with detecting blocked traffic flows in voice related services. As shown in FIG. 2, example 200 includes a service assurance platform 202, a cloud platform 204, a performance manager 206, an external events formulator system 230, and a voice traffic flow pattern repository 232. The service assurance platform 202 may include a batch job aggregator 208, a threshold region formulator 210, a region and time zone detector 212, a refined internal event generator 214, a multivariate composition parser 216, a threshold and actual value calculator 218, an internal and external system events dynamic correlator 220, an inventory and KPIs trends analyzer 222, a data consolidator 224, a workflow engine 226, and a notification service 228. The cloud platform 204 may include, in a first region, a media resource function 104 and a plurality of virtualized telephone application services, which may include a first virtualized telephone application service 102 and a second virtualized telephone application service 103. The cloud platform 204 may include, in a second region, a media resource function 108 and a plurality of virtualized telephone application services, which may include a first virtualized telephone application service 106 and a second vTAS virtualized telephone application service 107.

In some implementations, the performance manager 206 may receive KPIs related to audio or conference call control from media resource functions, where the performance manager 206 may relay the KPIs to the service assurance platform 202. As an example, the KPIs may be related to maximum concurrent audio call control and/or maximum concurrent conference call control. The performance manager 206 may consume, store, and/or manage real-time KPIs from different systems. The batch job aggregator 208 may allow a user to configure a job (or batch job) based on a network function type and respective selected KPIs. The job may be scheduled based on selected timeframes. The threshold region formulator 210 may allow the user to define thresholds for different network function applications deployed in different regions, and then associate the thresholds to the job. Different threshold formulas may be configured for different regions. The region and time zone detector 212 may be an intelligent detector that provides an appropriate time zone based on a region, which may include seasonal daylight savings criteria. The region and time zone detector 212 may be dynamically called by the threshold region formulator 210 to fetch a value and apply a specific threshold formula. The region and time zone detector 212 may be integrated with the threshold region formulator 210.

In some implementations, the refined internal event generator 214 may generate an appropriate event based on the job and the specific threshold formula. Information associated with the event may include an event name, region, time zone, daylight savings data, threshold, actual value, and/or a generated event timestamp. The multivariate composition parser 216 may process event data by extracting the information, such as the region, time zone, and/or daylight savings data, and then cross-check with systems data. The multivariate composition parser 216 may provide resulting parsed data to the threshold and actual value calculator 218.

In some implementations, the threshold and actual value calculator 218 may calculate a deviation between a threshold and an actual value, which may be based on the parsed data from the multivariate composition parser 216. The deviation may indicate an increased or decreased performance (e.g., KPIs) for specific media resource function KPIs. The internal and external system events dynamic correlator 220 may consider deviations for media resource function KPIs in specific regions, and then obtain relevant external events from the external events formulator system 230 for particular timestamps. The internal and external system events dynamic correlator 220 may dynamically correlate internal events processed data with the external system formulated data, and then derive observed values. The external system formulated data may be based on real-time status information of different systems. For example, the external system formulated data may be from an online platform that provides users with real-time information on the status of various services. No correlated occurrences data may be provided as non-matching data to the data consolidator 224. Correlated occurrences data may be provided as matched data to the data consolidator 224.

In some implementations, the inventory and KPIs trends analyzer 222 may collect media resource function and associated virtualized telephone application services inventory data, as well as collect last specified KPIs trend data. The data consolidator 224 may consolidate the media resource function and associated virtualized telephone application services inventory data, as well as the specified KPIs trend data. The data consolidator 224 may add information about specific thresholds, actual data values, and/or delta values (e.g., a delta between a threshold and an actual value in percentage). The data consolidator 224 may include dynamically correlated external data (e.g., affected audio calls or social media messages) with internal events data, when matched. The workflow service 226 may record workflow instance information and continue to keep track of processes that are executed. The notification service 228 may create consolidated data in a structured format with necessary recommendations. As an example, the recommendations may relate to rectifications of vTAS applications, vTAS application regions, and/or underlying platform routers. The notification service 228 may identify respective network engineers based on region information, and send appropriate notifications to user equipments (UEs) associated with the network engineers. In some cases, other actions may take place as a result of the notifications and/or the recommendations, such as artificial intelligence and/or machine learning (AI/ML) engine analysis and/or self-optimization. The consolidated data may be associated with voice traffic flow patterns, which may be stored in the voice traffic flow pattern repository 232 and be used for future predictions.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

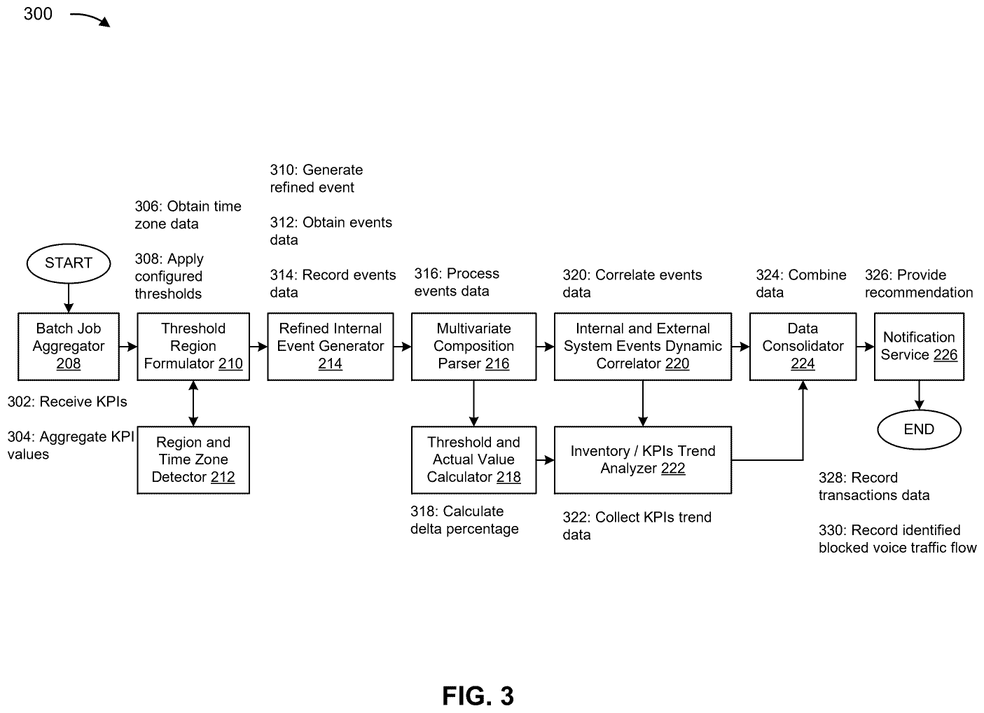

FIG. 3 is a diagram of an example 300 associated with detecting blocked traffic flows in voice related services. As shown in FIG. 3, example 300 includes a batch job aggregator 208, a threshold region formulator 210, a region and time zone detector 212, a refined internal event generator 214, a multivariate composition parser 216, a threshold and actual value calculator 218, an internal and external system events dynamic correlator 220, an inventory and KPIs trends analyzer 222, a data consolidator 224, and a notification service 228.

As shown by reference number 302, the batch job aggregator 208 may receive KPIs from a performance manager, where the KPIs may be related to media resource functions. As shown by reference number 304, the batch job aggregator 208 may collect and aggregate specific KPI values based on a defined granularity time setup. As shown by reference number 306, the threshold region formulator 210 may obtain time zone data (with daylight savings data, UMT time data, etc.), which may be specific to a region from the region and time zone detector 212. As shown by reference number 308, the threshold region formulator 210 may apply configured threshold equations for different region-based KPIs. As shown by reference number 310, the refined internal event generator 214 may determine whether the configured threshold equations cross a defined threshold, and if so, the threshold region formulator 210 may generate a refined internal event. As shown by reference number 312, the refined internal event generator 214 may obtain event data, which may include an event occurrence timestamp, a specific threshold, an actual value, and/or region and media resource function application data. As shown by reference number 314, occurrent refined internal events data may be recorded into a database (e.g., a database associated with a workflow engine (e.g., shown in FIG. 2)), and the multivariate composition parser 216 may be invoked for further processing.

As shown by reference number 316, the multivariate composition parser 216 may process events data by extracting region, time zone, and/or daylight savings data, and then cross- checking with systems data. The multivariate composition parser 216 may provide parsed data (or broken data) to the threshold and actual value calculator 218. As shown by reference number 318, the threshold and actual value calculator 218 may calculate a delta percentage value between the threshold and the received actual value. As shown by reference number 320, the internal and external system events dynamic correlator 220 may query an external events formulator system (shown in FIG. 2) with specific conditions, and then perform a dynamic correlation using refined events data. The internal and external system events dynamic correlator 220 may dynamically correlate internal events process data and external system formulated data, and then derive observed values. No correlated occurrences data may be provided as non- matching data to the data consolidator 224. Correlated occurrences data may be provided as matched data to the data consolidator 224.

As shown by reference number 322, the inventory and KPIs trends analyzer 222 may obtain additional media resource function application and associated virtualized telephone application services inventory data. The inventory and KPIs trends analyzer 222 may collect a last specified KPIs trend data, and then inventory and KPIs data may be provided to the data consolidator 224. As shown by reference number 324, the data consolidator 224 may combine all data when matched, where the data may be associated with inventory data, KPIs, thresholds, actual values, delta percentage values, and/or external events data. As shown by reference number 326, the notification service 228 may create consolidated data in a structured format with necessary recommendations. The notification service 228 may identify respective network engineers based on region information, and send appropriate notifications to user equipment (UEs) associated with the network engineers.

As shown by reference number 328, the workflow engine may record all transaction data into a database. When no exceptions occur, the workflow may end successfully. When any exceptions occur, failures may be recorded and the workflow may be ended gracefully. As shown by reference number 330, the workflow engine may record an identified block voice traffic flow, along with inventory, KPIs, timestamps, and provided recommendations into a repository for future predictions.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

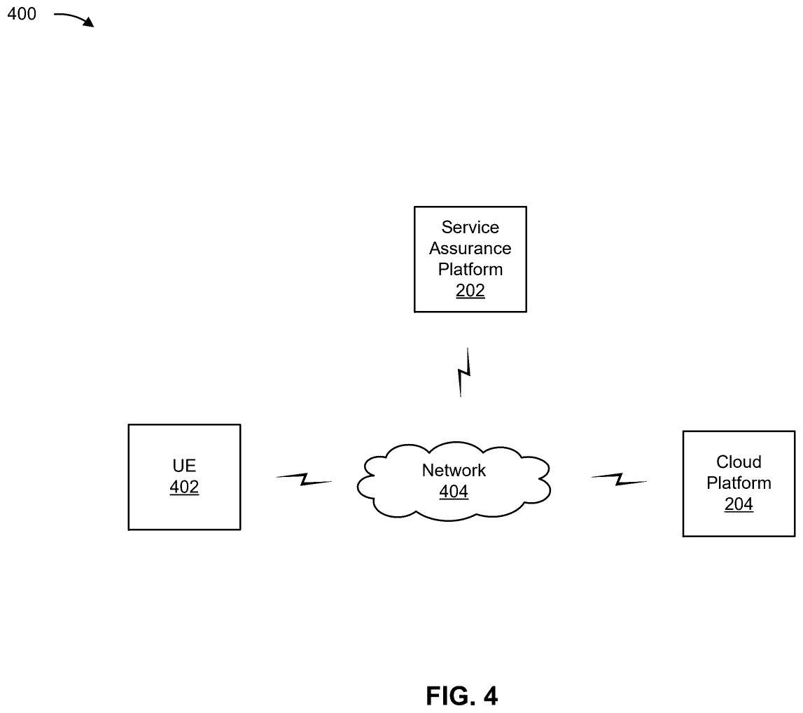

FIG. 4 is a diagram of an example environment 400 in which systems and/or methods described herein may be implemented. As shown in FIG. 4, environment 400 may include a UE 402, a service assurance platform 202, a cloud platform 204, and a network 404. Devices of environment 400 may interconnect via wired connections, wireless connections, or a combination of wired and wireless connections.

The UE 402 may include one or more devices capable of receiving, generating, storing, processing, and/or providing information associated with detecting blocked traffic flows in voice related services, as described elsewhere herein. The UE 402 may include a communication device and/or a computing device. For example, the UE 402 may include a wireless communication device, a mobile phone, a laptop computer, a tablet computer, a desktop computer, a gaming console, a set-top box, a wearable communication device (e.g., a smart wristwatch, a pair of smart eyeglasses, a head mounted display, or a virtual reality headset), a smart television, an Internet of Things (IoT) device, or a similar type of device.

The service assurance platform 202 may include one or more devices (e.g., network devices) capable of receiving, generating, storing, processing, providing, and/or routing information associated with detecting blocked traffic flows in voice related services, as described elsewhere herein. The service assurance platform 202 may include one or more communication devices and/or one or more computing devices. The service assurance platform 202 may include one or more servers in a cloud computing system. The service assurance platform 202 may include computing hardware used in a cloud computing environment. The service assurance platform 202 may run various applications, services, and/or functions.

The cloud platform 204 may include one or more devices (e.g., network devices) capable of receiving, generating, storing, processing, providing, and/or routing information associated with detecting blocked traffic flows in voice related services, as described elsewhere herein. The cloud platform 204 may include a communication device and/or a computing device. For example, the cloud platform 204 may include a server, such as an application server, a client server, a web server, a database server, a host server, a proxy server, a virtual server (e.g., executing on computing hardware), or a server in a cloud computing system. In some implementations, the cloud platform 204 may include computing hardware used in a cloud computing environment.

The network 404 may include one or more wired and/or wireless networks. For example, the network 404 may include a cellular network (e.g., a 5G network, a 4G network, a LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 404 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

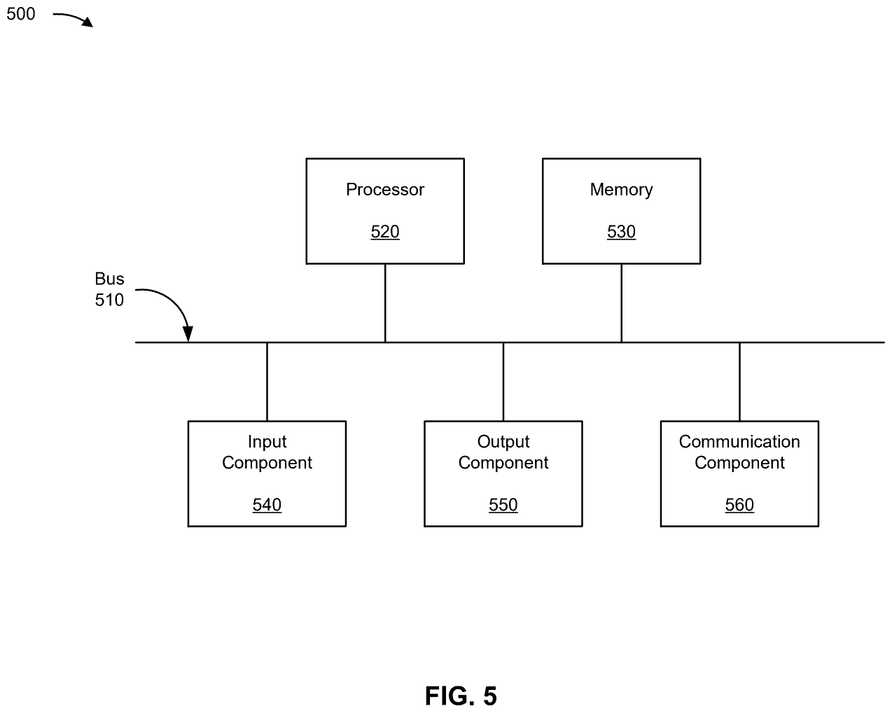

FIG. 5 is a diagram of example components of a device 500 associated with detecting blocked traffic flows in voice related services. The device 500 may correspond to a network device (e.g., batch job aggregator 208, threshold region formulator 210, region and time zone detector 212, refined internal event generator 214, multivariate composition parser 216, threshold and actual value calculator 218, internal and external system events dynamic correlator 220, inventory and KPIs trends analyzer 222, data consolidator 224, workflow engine 226, or notification service 228). In some implementations, the network device may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

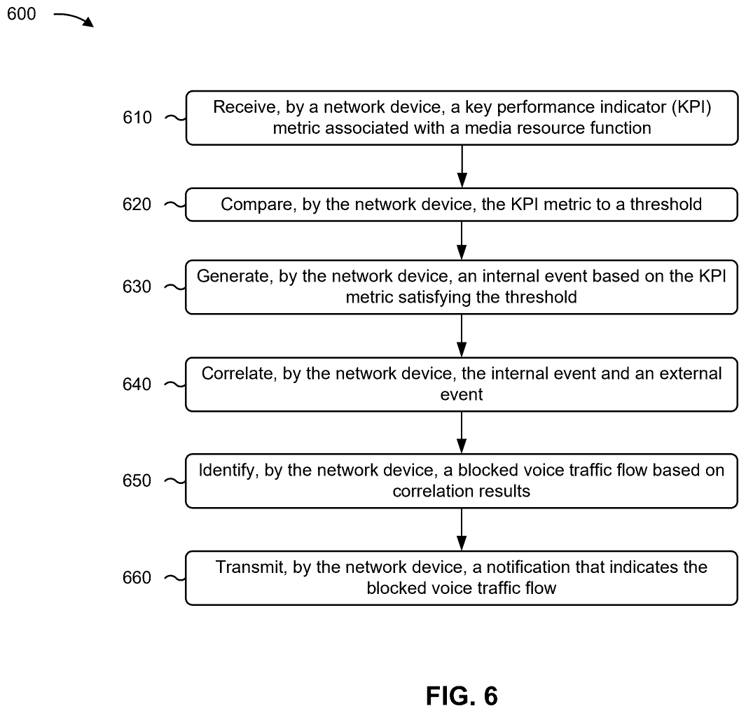

FIG. 6 is a flowchart of an example process 600 associated with detecting blocked traffic flows in voice related services. In some implementations, one or more process blocks of FIG. 6 may be performed by a network device (e.g., batch job aggregator 208, threshold region formulator 210, region and time zone detector 212, refined internal event generator 214, multivariate composition parser 216, threshold and actual value calculator 218, internal and external system events dynamic correlator 220, inventory and KPIs trends analyzer 222, data consolidator 224, workflow engine 226, or notification service 228). In some implementations, one or more process blocks of FIG. 6 may be performed by another entity or a group of entities separate from or including the network device. Additionally, or alternatively, one or more process blocks of FIG. 6 may be performed by one or more components of device 500, such as processor 520, memory 530, input component 540, output component 550, and/or communication component 560.

As shown in FIG. 6, process 600 may include receiving, by the network device, a key performance indicator (KPI) metric associated with a media resource function, wherein the media resource function is associated with a virtualized telephone application service (block 610). The virtualized telephone application service may be configured to provide a VoLTE service. The KPI metric may be associated with a voice call.

As shown in FIG. 6, process 600 may include comparing, by the network device, the KPI metric to a threshold (block 620). The threshold may be a region-based threshold configured for a region associated with the KPI metric or a time zone based threshold configured for a time zone associated with the KPI metric. Different thresholds may be configured for different network function applications deployed in different regions.

As shown in FIG. 6, process 600 may include generating, by the network device, an internal event based on the KPI metric satisfying the threshold (block 630). The network device may obtain, for the internal event, one or more of: an event occurrence timestamp, the threshold, an actual value of the KPI metric, or region and media resource function application data. The network device may store a record of the internal event.

As shown in FIG. 6, process 600 may include correlating, by the network device, the internal event and an external event, wherein the external event is based on external system formulated data, and results of the correlating include an indication of non-matching data or matched data between the internal event and the external event (block 640). The external system formulated data may be associated with the region. The external system formulated data may be dated, gathered, and/or received within a defined time range from a timestamp associated with the KPI metric.

As shown in FIG. 6, process 600 may include identifying, by the network device, a blocked voice traffic flow based on the correlation results (block 650). The correlation results, which may indicate non-matching data or matched data between the internal event and the external event, may indicate whether a voice traffic flow is blocked or partially blocked.

As shown in FIG. 6, process 600 may include transmitting, by the network device, a notification that indicates the blocked voice traffic flow, wherein the notification includes a recommendation to resolve the blocked voice traffic flow (block 660). The recommendation may result in a modified KPI metric for a media resource function associated with the voice traffic flow, which may improve an audio quality of audio calls.

In some implementations, the network device may calculate a delta value between the threshold and the actual value, wherein the delta value indicates a performance level of a media resource function KPI. The network device may store a record of the delta value. The network device may collect media resource function data and associated virtualized telephone application service inventory data. The network device may collect last specified KPIs trend data. The network device may consolidate one or more of the KPI metric, the threshold, the actual value, the delta value, the indication of the non-matching data or matched data, the media resource function data and associated virtualized telephone application service inventory data, and the last specified KPIs trend data, to form consolidated data. The network device may transmit the consolidated data as part of the notification. The network device may store a record of the recommendation in a data repository for blocked voice traffic flow predictions.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device, a key performance indicator (KPI) metric associated with a media resource function, wherein the media resource function is associated with a virtualized telephone application service;
comparing, by the network device, the KPI metric to a threshold;
generating, by the network device, an internal event based on the KPI metric satisfying the threshold;
correlating, by the network device, the internal event and an external event, wherein the external event is based on external system formulated data, and results of the correlating include an indication of non-matching data or matched data between the internal event and the external event;
identifying, by the network device, a blocked voice traffic flow based on the correlation results; and
transmitting, by the network device, a notification that indicates the blocked voice traffic flow, wherein the notification includes a recommendation to resolve the blocked voice traffic flow.

2. The method of claim 1, wherein the threshold is one or more of a region-based threshold configured for a region associated with the KPI metric or a time zone based threshold configured for a time zone associated with the KPI metric.

3. The method of claim 2, wherein the external system formulated data is associated with the region, and the external system formulated data is within a defined time range from a timestamp associated with the KPI metric.

4. The method of claim 1, further comprising:
obtaining, by the network device and for the internal event, one or more of: an event occurrence timestamp, the threshold, an actual value of the KPI metric, region data, or media resource function application data.

5. The method of claim 1, further comprising:
calculating, by the network device, a delta value between the threshold and an actual value of the KPI metric, wherein the delta value indicates a performance level of a media resource function KPI; and
storing, by the network device, a record of the delta value.

6. The method of claim 1, further comprising:
collecting, by the network device, media resource function data and associated virtualized telephone application service inventory data; and
collecting, by the network device, last specified KPIs trend data.

7. The method of claim 1, further comprising:
consolidating, by the network device, one or more of the KPI metric, the threshold, an actual value of the KPI metric, a delta value between the threshold and the actual value of the KPI metric, the indication of non-matching data or matched data, media resource function data and associated virtualized telephone application service inventory data, and last specified KPIs trend data, to form consolidated data; and
transmitting, by the network device, the consolidated data as part of the notification.

8. The method of claim 1, further comprising:
storing, by the network device, a record of the recommendation in a data repository for blocked voice traffic flow predictions.

9. The method of claim 1, wherein the virtualized telephone application service is configured to provide a voice over Long Term Evolution (VoLTE) service.

10. The method of claim 1, wherein the KPI metric is associated with a voice call.

11. A network device, comprising:
one or more processors configured to:
receive a key performance indicator (KPI) metric associated with a media resource function, wherein the media resource function is associated with a virtualized telephone application service;
compare the KPI metric to a threshold;
generate an internal event based on the KPI metric satisfying the threshold;
correlate the internal event and an external event, wherein the external event is based on external system formulated data, and correlation results include an indication of non-matching data or matched data between the internal event and the external event;
identify a blocked voice traffic flow based on the correlation results; and
transmit a notification that indicates the blocked voice traffic flow, wherein the notification includes a recommendation to resolve the blocked voice traffic flow.

12. The network device of claim 11, wherein:
the threshold is a region-based threshold configured for a region associated with the KPI metric,
the threshold is a time zone based threshold configured for a time zone associated with the KPI metric,
the external system formulated data is associated with the region, and
the external system formulated data is dated within a defined time range from a timestamp associated with the KPI metric.

13. The network device of claim 11, wherein the one or more processors are further configured to:
obtain, for the internal event, one or more of: an event occurrence timestamp, the threshold, an actual value of the KPI metric, or region and media resource function application data;
calculate a delta value between the threshold and the actual value, wherein the delta value indicates a performance level of a media resource function KPI;
collect media resource function data and associated virtualized telephone application service inventory data;
collect last specified KPIs trend data;
consolidate one or more of the KPI metric, the threshold, the actual value, the delta value, the indication of the non-matching data or matched data, the media resource function data and associated virtualized telephone application service inventory data, and the last specified KPIs trend data, to form consolidated data; and
transmit the consolidated data as part of the notification.

14. The network device of claim 11, wherein the one or more processors are further configured to:
store a record of the recommendation in a data repository for blocked voice traffic flow predictions.

15. The network device of claim 11, wherein the virtualized telephone application service is configured to provide a voice over Long Term Evolution (VoLTE) service, and the KPI metric is associated with a voice call.

16. A non-transitory computer-readable medium storing a set of instructions, the set of instructions comprising:
one or more instructions that, when executed by one or more processors of a network device, cause the network device to:
receive a key performance indicator (KPI) metric associated with a media resource function, wherein the media resource function is associated with a virtualized telephone application service;
compare the KPI metric to a threshold;
generate an internal event based on the KPI metric satisfying the threshold;
correlate the internal event and an external event, wherein the external event is based on external system formulated data, and correlation results include an indication of non-matching data or matched data between the internal event and the external event;
identify a blocked voice traffic flow based on the correlation results; and
transmit a notification that indicates the blocked voice traffic flow, wherein the notification includes a recommendation to resolve the blocked voice traffic flow.

17. The non-transitory computer-readable medium of claim 16, wherein:
the threshold is a region-based threshold configured for a region associated with the KPI metric,
the threshold is a time zone based threshold configured for a time zone associated with the KPI metric,
the external system formulated data is associated with the region, and
the external system formulated data is dated within a defined time range from a timestamp associated with the KPI metric.

18. The non-transitory computer-readable medium of claim 16, wherein the one or more instructions, when executed by the one or more processors, further cause the network device to:
obtain, for the internal event, one or more of: an event occurrence timestamp, the threshold, an actual value of the KPI metric, or region and media resource function application data;
calculate a delta value between the threshold and the actual value, wherein the delta value indicates a performance level of a media resource function KPI;
collect media resource function and associated virtualized telephone application service inventory data;
collect last specified KPIs trend data;
consolidate one or more of the KPI metric, the threshold, the actual value, the delta value, the indication of the non-matching data or matched data, the media resource function and associated virtualized telephone application service inventory data, and the last specified KPIs trend data, to form consolidated data; and
transmit the consolidated data as part of the notification.

19. The non-transitory computer-readable medium of claim 16, wherein the one or more instructions, when executed by the one or more processors, further cause the network device to:
store a record of the recommendation in a data repository for blocked voice traffic flow predictions.

20. The non-transitory computer-readable medium of claim 16, wherein the virtualized telephone application service is configured to provide a voice over Long Term Evolution (VoLTE) service, and the KPI metric is associated with a voice call.
